(19) United States
(12) Patent Application Publication
(10) Pub. No.: US 2020/0291919 A1
(43) Pub. Date: Sep. 17, 2020

(54) VERTICAL AXIS TURBINE BLADE, TURBINE AND WIND POWER GENERATION DEVICE

(71) Applicants: Bill Loh, Singapore (SG); Wang Fung Samuel Cheung, Hong Kong (HK); Wang Fai Victor Cheung, Hong Kong (HK); Wai Hung Lee, Hong Kong (HK)

(72) Inventors: Bill Loh, Singapore (SG); Wang Fung Samuel Cheung, Hong Kong (HK); Wang Fai Victor Cheung, Hong Kong (HK); Wai Hung Lee, Hong Kong (HK)

(21) Appl. No.: 16/649,169

(22) PCT Filed: Sep. 12, 2018
(86) PCT No.: PCT/CN2018/105146

§ 371 Date: Mar. 20, 2020

(30) Foreign Application Priority Data
Sep. 20, 2017 (CN) 201710849269.0

(51) Int. Cl. F03D 3/06; F03D 3/00; F03D 15/00; F03D 9/25; H02K 7/18

(52) U.S. Cl. CPC F03D 3/062; F03D 3/005; H02K 7/183; F03D 9/25; F03D 15/00

(57) ABSTRACT

A vertical axis wind turbine blade (100), vertical axis wind turbine (200) and a wind power generation device, the outer profile (110) of the cross section perpendicular to the vertical axis of the vertical axis turbine blade (100) is part of a NACA four digit series symmetrical airfoil profile, the outer profile (110) has a first opening (111), and the cross section of the inner profile (120) curves inwardly to form a wind scoop (130); the vertical axis wind turbine (200) comprises rotor shafts (210, 220) and at least two vertical axis wind turbine blades (100) disposed on uniform axes and surrounding the rotor shafts (210, 220); the vertical axis wind power generation device comprises a generator and a vertical axis turbine (200).

### TECHNICAL FIELD

The present disclosure relates to the technical field of wind power generation, more particularly to a vertical axis wind turbine blade, a turbine and a wind power generation device.

### BACKGROUND ART

Wind power generators can be divided into horizontal axis wind power generators and vertical axis wind power generators according to different relative positional relations of rotating shafts, and the horizontal axis wind power generators are relatively common wind power generation devices at present, but in recent years, the vertical axis wind power generators are also rapidly developed and increasingly widely applied. The wind turbine blade is a key part of the vertical axis wind power generator, and the shape of the wind turbine blade directly affects the startup performance and the wind energy utilization efficiency of the vertical axis wind power generator.

### SUMMARY

One of the objects of the present disclosure is to provide a vertical axis wind turbine blade having a high efficiency.

According to an embodiment of a vertical axis wind turbine blade of the present disclosure, an outer profile of a cross section of the vertical axis wind turbine blade is a part of a symmetrical airfoil profile with the cross section being perpendicular to a vertical axis, the outer profile has a first opening, and an inner profile of the cross section is curved inwards to form a wind scoop.

According to an embodiment of the vertical axis wind turbine blade of the present disclosure, the symmetric airfoil profile is a first symmetrical airfoil profile of NACA four digit series, with the symmetrical airfoil profile defined by the following equation:

y=5t/c[0.2969 \sqrt{x/c}−0.126(x/c)−0.3516(x/c)²+0.2843(x/c)³−0.1015(x/c)⁴]

where t is a thickness of the first symmetrical airfoil profile of NACA four digit series, and c is a chord length.

According to an embodiment of the vertical axis wind turbine blade of the present disclosure, the inner profile is a part of a modified second symmetric airfoil profile of NACA four digit series, a part of the second symmetric airfoil profile of NACA four digit series has a second opening, and the modified second symmetrical airfoil profile of NACA four digit series is defined by the following equation:

$$y cos β - \frac{{w}_{1}}{{w}_{2}} x sin β = 5 {t}^{′} ( 0.2969 {m}^{0.5} - 0.126 m - 0.3516 {m}^{2} + 0.2843 {m}^{3} - 0.1015 {m}^{4} )$$

$$where$$

$$m = \frac{{w}_{1} cos β}{{w}_{2} c} x + \frac{sin β}{c} y + 1 , β = {tan}^{- 1} \frac{{y}_{3} - 0.0105 {t}^{′}}{c - {x}_{3}} ,$$

(x₃, y₃) is coordinates of terminus of the second opening, w₁ is a width of the first opening, w₂ is a width of the second opening, and t′ is thickness of the second symmetrical airfoil profile of NACA four digit series.

According to an embodiment of the vertical axis wind turbine blade of the present disclosure, the first opening has an arc length that is 10%˜90% of the length of an upper arc of the first symmetrical airfoil profile of NACA four digit series, and the second opening has an arc length that is 10%˜90% of the length of an upper arc of the second symmetrical airfoil profile of NACA four digit series.

According to an embodiment of the vertical axis wind turbine blade of the present disclosure, an inner cavity sandwich layer is formed between the outer profile and the inner profile, the inner cavity sandwich layer has a reinforcement structure, and the reinforcement structure is a grid-like reinforcement structure or a reinforcement structure composed of ribbed plates and ribs.

Another object of the present disclosure is to provide a vertical axis rotor.

According to an embodiment of the vertical axis rotor of the present disclosure, the vertical axis rotor includes a rotor shaft and two or more vertical axis wind turbine blades as described above which are provided evenly around an axis of the rotor shaft.

According to an embodiment of the vertical axis rotor of the present disclosure, the vertical axis rotor includes an upper end cap and a lower end cap which are connected with the rotor shaft, and three vertical axis wind turbine blades are provided, wherein upper ends of the vertical axis wind turbine blades are connected with the upper end cap, and lower ends of the vertical axis wind turbine blades are connected with the the lower end cap.

According to an embodiment of the vertical axis rotor of the present disclosure, an angle of 0˜120 degrees is included between a radial direction of the vertical axis rotor and a chord line of the outer profile of a cross section of each of the vertical axis wind turbine blades, with the cross section perpendicular to the vertical axis.

According to an embodiment of the vertical axis rotor of the present disclosure, when wind blows toward the vertical axis rotor, a wind scoop of a wind turbine blade on a windward side directly converts the coming airflow into kinetic energy, the rest of the airflow blows to the other two wind turbine blades, and the airflow acceleratedly flowing over cambered surfaces of the other two wind turbine blades forms negative pressure so as to increase a rotating speed and a torque of the wind turbine blades.

A further object of the present disclosure is to provide a vertical axis wind power generation device.

According to an embodiment of the vertical axis wind power generation device of the present disclosure, the vertical axis wind power generation device includes a power generator and the vertical axis rotor as described above, and a rotating shaft of the power generator is connected with the rotor shaft of the vertical axis rotor.

In the present disclosure, the outer profile of the vertical axis wind turbine blades adopt the symmetrical airfoil profile of NACA four digit series, wherein the inner profile is curved inwards to form the wind scoop, and when wind blows to the wind turbine blades, the wind scoop can directly convert airflow into kinetic energy, and airflow acceleratedly flowing over the cambered surfaces of the outer profiles of the wind turbine blades can produce negative pressure so as to increase the rotating speed and the torque of the wind turbine blades.

### BRIEF DESCRIPTION OF DRAWINGS

Below the present disclosure will be further described in combination with accompanying drawings and embodiments, and in the accompanying drawings:

FIG. 1 is a cross-sectional diagram of an embodiment of a vertical axis wind turbine blade of the present disclosure;

FIG. 2 is a perspective schematic diagram of an embodiment of a vertical axis rotor of the present disclosure;

FIG. 3 is a structural schematic diagram of the vertical axis rotor shown in FIG. 2;

FIG. 4 is a schematic diagram of wind turbine blades of the vertical axis rotor shown in FIG. 2;

FIG. 5 is a cross-sectional diagram of the vertical axis rotor shown in FIG. 2;

FIG. 6 is a schematic diagram of an symmetrical airfoil profile of NACA four digit series;

FIG. 7 is a simulation schematic diagram of the vertical axis rotor shown in FIG. 2 under wind action; and

FIG. 8 is a cross-sectional diagram of another embodiment of the vertical axis wind turbine blade of the present disclosure.

### DETAILED DESCRIPTION OF EMBODIMENTS

For the sake of clearer understanding of technical features, objects and effects of the present disclosure, specific embodiments of the present disclosure will now be described in detail with reference to the accompanying drawings.

Embodiments of a vertical axis wind turbine blade, a turbine and a wind power generation device of the present disclosure are described in detail below, and examples of these embodiments are shown in the accompanying drawings, in which same or similar signs represent same or similar elements or elements having same or similar functions throughout the accompanying drawings.

In the description of the vertical axis wind turbine blade, the turbine and the wind power generation device of the present disclosure, it should be understood that orientational or positional relations indicated by terms “front”, “rear”, “upper”, “lower”, “upper end”, “lower end”, “upper part”, “lower part” and so on are based on orientational or positional relations shown in the accompanying drawings, merely for facilitating the description of the present disclosure and simplifying the description, rather than indicating or implying that related devices or elements have to be in the specific orientation or configured and operated in a specific orientation, and therefore, they should not be construed as limitation on the present disclosure. Besides, terms “first”, “second” and so on are merely used for descriptive purpose, but should not be construed as indicating or implying relative importance.

The NACA airfoil profile described in the present disclosure is a series of airfoil profiles developed by National Advisory Committee for Aeronautics (NACA), USA. The code of each airfoil profile consists of four letters “NACA” and a series of digits, and a precise shape of the airfoil profile can be obtained just by substituting geometric parameters described by the series of digits into a specific equation.

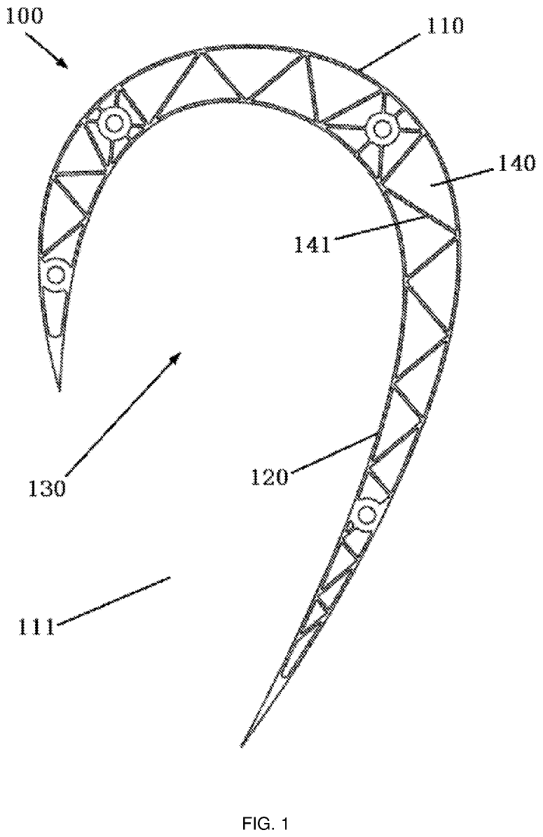

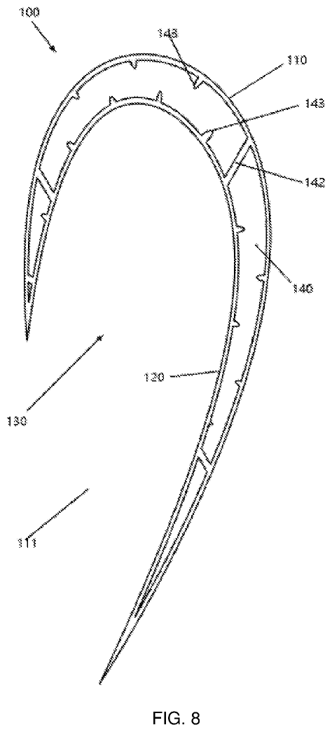

As shown in FIG. 1, it is a cross-sectional diagram of an embodiment of a vertical axis wind turbine blade of the present disclosure, wherein this cross section is a cross section of the vertical axis wind turbine blade perpendicular to a vertical axis. The cross section of the vertical axis wind turbine blade 100 has an outer profile 110 and an inner profile 120, wherein the outer profile 110 has a first opening 111, the outer profile 110 is a part of a symmetrical airfoil profile of NACA four digit series, that is, the outer profile 110 is a part of the symmetrical airfoil profile among the airfoil profiles of NACA four-digit series, and the inner profile 120 is curved inwards to form a wind scoop 130. The vertical axis wind turbine blade 100 of the present disclosure may be made of lightweight alloy materials or composite materials having relatively high strength, or made of from lightweight alloy materials and composite materials, such as aluminum alloys and other commonly used materials. In order to increase the strength of the vertical axis wind turbine blade 100, a grid-like reinforcement structure 141 can be provided in an inner cavity sandwich layer 140 formed between the outer profile 110 and the inner profile 120, so as to enhance the overall strength of the vertical axis wind turbine blade 100. The grid-like reinforcement structure 141 is preferably a triangular grid, but is not limited to the triangular grid, and may also be a quadrilateral grid, a pentagonal grid or other polygonal grids or grids having other shapes. In the cross-sectional diagram of another embodiment of the vertical axis wind turbine blade as shown in FIG. 8, the reinforcement structure of the inner cavity sandwich layer 140 formed between the outer profile 110 and the inner profile 120 of the vertical axis wind turbine blade 100 is composed of ribbed plates 142 and ribs 143, wherein each ribbed plate 142 has one side connected with the outer profile 110, and the other side connected with the inner profile 120, and the ribs 143 can be formed on an inner side of the outer profile 110 or on an inner side of the inner profile 120. The presence of the ribbed plates 142 and the ribs 143 can enhance the strength of the entire vertical axis wind turbine blade 100.

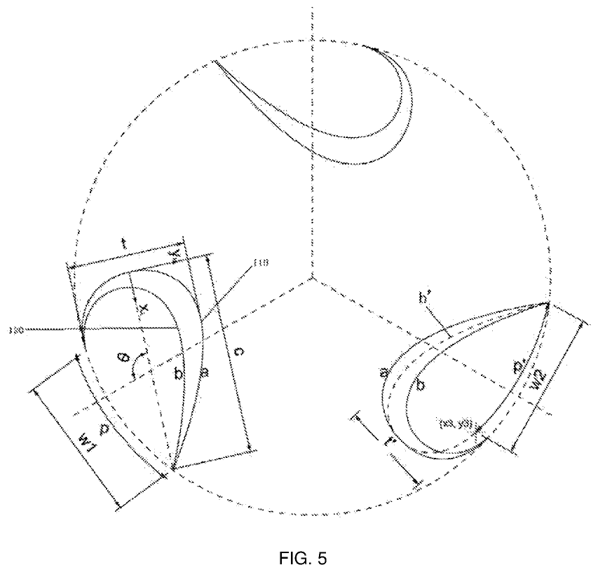

Referring to FIG. 5, in an embodiment of the vertical axis wind turbine blade of the present disclosure, the outer profile 110, i.e. curve a in the figure, which is a part of the symmetrical airfoil profile among the airfoil profiles of NACA four digit series, and has a shape defined by the following equation:

y=5t/c[0.2969 \sqrt{x/c}−0.126(x/c)−0.3516(x/c)²+0.2843(x/c)³−0.1015(x/c)⁴]

where t is a thickness of the symmetrical airfoil profile, and c is a chord length.

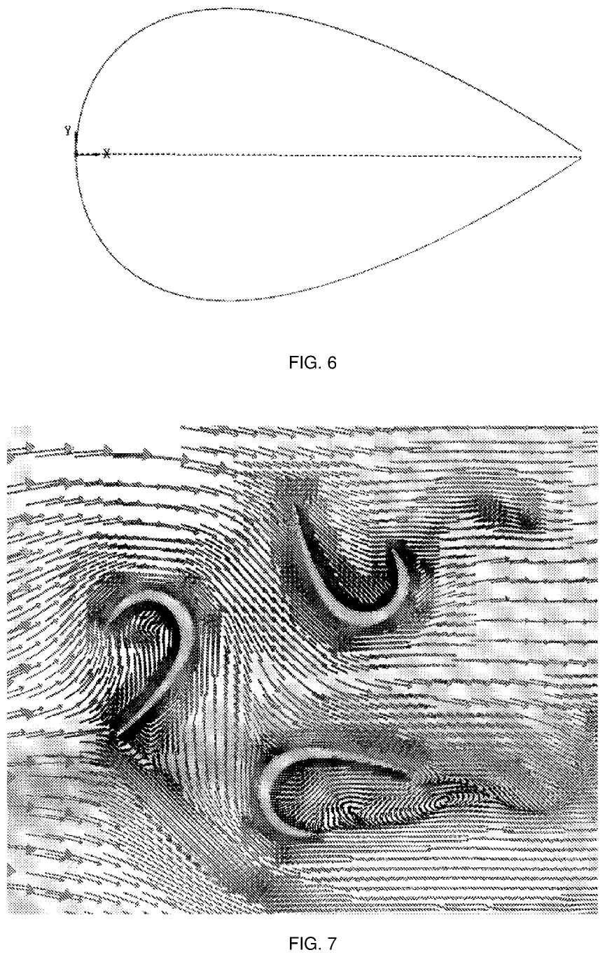

The curve a, i.e. the outer profile 110, has a first opening p, and an arc length of the first opening p is 10%˜90% of the length of an upper arc of the symmetrical airfoil profile of NACA four digit series. Referring to FIG. 6, a schematic diagram of the symmetrical airfoil profile of NACA four digit series, the upper arc is a curve of an upper half of the symmetrical airfoil profile.

Referring to FIG. 5, in an embodiment of the vertical axis wind turbine blade of the present disclosure, the inner profile 120, i.e. curve b in the figure, which is a part of a modified symmetrical airfoil profile of NACA four digit series, the modified symmetrical airfoil profile is obtained by modifying a curve b′ upon rotation and scaling so as to match openings w1 and w2, such that two corresponding openings coincide end to end. The b′, a part of a unmodified symmetrical airfoil profile of NACA four digit series, which has a second opening p′, and the modified second symmetric airfoil profile of NACA four digit series, i.e. curve b, is defined by the following equation:

$$y cos β - \frac{{w}_{1}}{{w}_{2}} x sin β = 5 {t}^{′} ( 0.2969 {m}^{0.5} - 0.126 m - 0.3516 {m}^{2} + 0.2843 {m}^{3} - 0.1015 {m}^{4} )$$

$$where$$

$$m = \frac{{w}_{1} cos β}{{w}_{2} c} x + \frac{sin β}{c} y + 1 , β = {tan}^{- 1} \frac{{y}_{3} - 0.0105 {t}^{′}}{c - {x}_{3}} ,$$

(x₃, y₃) is coordinates of terminus of the second opening p′, w₁ is a width of the first opening p, w₂ is a width of the second opening p′, and t′ is the thickness of the symmetrical airfoil profile of NACA four digit series, i.e. thickness of the symmetrical airfoil profile of NACA four digit series corresponding to the curve b′. The second opening p′ has an arc length that is 10%˜90% of the length of the upper arc of the symmetrical airfoil profile of NACA four digit series.

It should be understood that the specific curve equations above are merely illustrative rather than restrictive, and that the curves of the outer profile and the inner profile of the vertical axis wind turbine blade of the present disclosure may be a part of other symmetrical airfoil profiles, and are not limited to the specific equations above, nor to the symmetrical airfoil profiles of NACA four digit series.

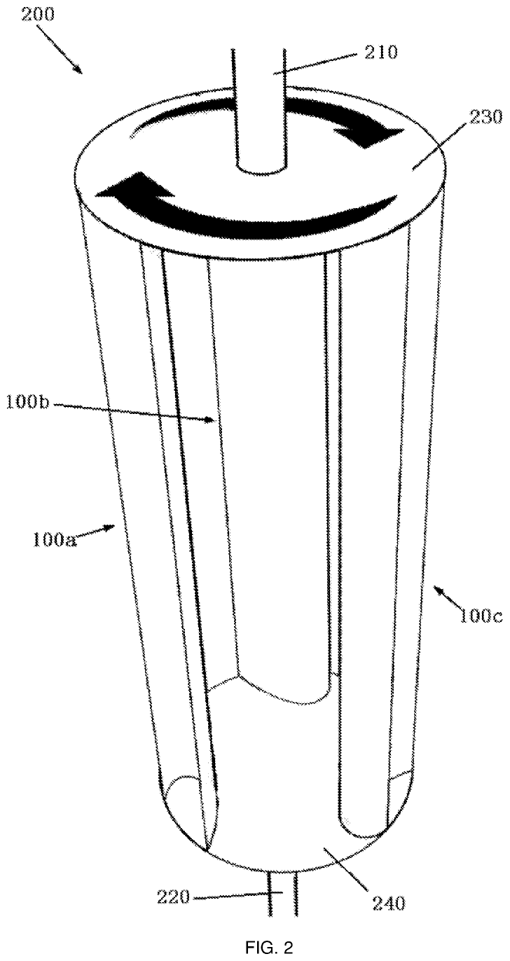

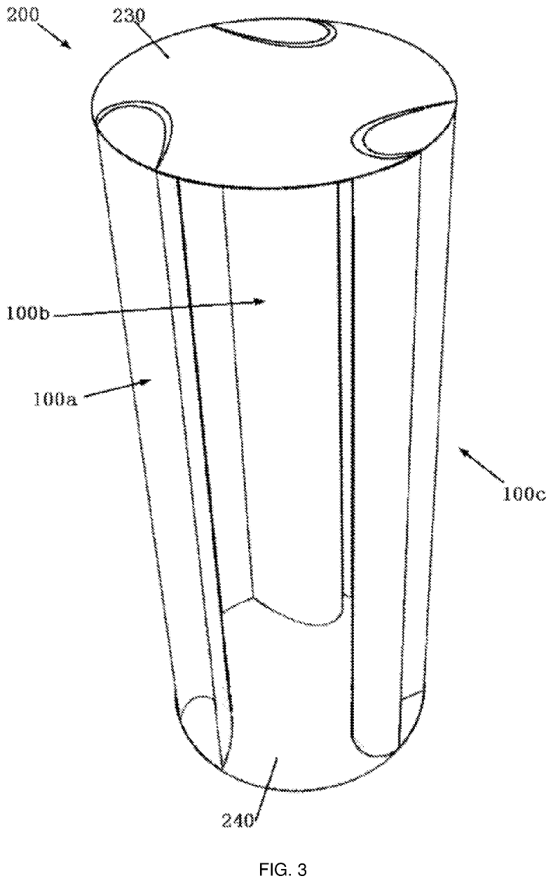

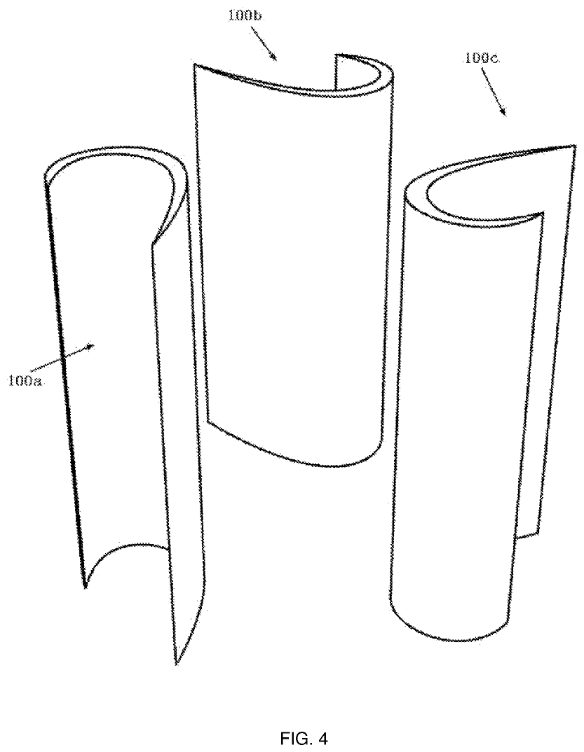

Referring to FIG. 2 to FIG. 5, which are schematic diagrams of an embodiment of a vertical axis rotor of the present disclosure, the vertical axis rotor (or wind turbine) 200 includes rotor shafts (or wind turbine shafts) 210 and 220, and three vertical axis wind turbine blades 100a, 100b, and 100c provided evenly around axes of the rotor shafts 210 and 220, the rotor shaft 210 is connected with an upper end cap 230, upper ends of the vertical axis wind turbine blades 100a, 100b, and 100c are connected with the upper end cap 230, respectively, lower ends of the vertical axis wind turbine blades 100a, 100b, and 100c are connected with a lower end cap 240, respectively, and the lower end cap 240 is connected with the rotor shaft 220. An angle of 0˜120 degrees is included between a radial direction of the vertical axis rotor 200 and a chord line of an outer profile of a cross section of each of the vertical axis wind turbine blades 100a, 100b, and 100c, with the cross section perpendicular to the vertical axes.

It should be understood that the number of wind turbine blades of the vertical axis rotor 200 of the present disclosure is not limited to three, and may be two or other numbers.

Referring to FIG. 7, when wind blows toward the vertical axis rotor 200, a wind scoop of a wind turbine blade on a windward side directly converts the coming airflow into kinetic energy, and after passing over the first wind turbine blade, the airflow flows onto arcs of the second and the third wind turbine blades, then the airflow acceleratedly flowing over the second and third wind turbine blades provides a lift force which cooperates with a centripetal force of the wind turbine blades, thus a rotational torque and speed of the entire vertical axis rotor are increased, thereby improving the efficiency of the vertical axis wind turbine.

In addition to the vertical axis wind turbine blades and the vertical axis rotor described above, the present disclosure further provides a vertical axis wind power generation device, including a power generator and the vertical axis rotor as described above, wherein a rotating shaft of the power generator is connected with the rotor shafts of the vertical axis rotor.

The embodiments of the present disclosure are described above in conjunction with the accompanying drawings, but the present disclosure is not limited to the above specific embodiments. The above specific embodiments are merely illustrative, rather than restrictive, and those ordinarily skilled in the art still could obtain many forms in light of the present disclosure without departing from the essence of the present disclosure and, and these forms shall be covered by the scope of protection of the present disclosure.

1. A vertical axis wind turbine blade, characterized in that an outer profile of a cross section of the vertical axis wind turbine blade is a part of a symmetrical airfoil profile, with the cross section being perpendicular to a vertical axis, wherein the outer profile has a first opening, and an inner profile of the cross section is curved inwards to form a wind scoop.

2. The vertical axis wind turbine blade according to claim 1, characterized in that the symmetric airfoil profile is a first symmetrical airfoil profile of NACA (National Advisory Committee for Aeronautics) four digit series, and the first symmetrical airfoil profile of NACA four digit series is defined by following equation:
y=5t/c[0.2969 \sqrt{x/c}−0.126(x/c)−0.3516(x/c)²+0.2843(x/c)³−0.1015(x/c)⁴]
where t is a thickness of the first symmetrical airfoil profile of NACA four digit series, and c is a chord length.

3. The vertical axis wind turbine blade according to claim 2, characterized in that the inner profile is a part of a modified second symmetric airfoil profile of NACA four digit series, wherein a part of the second symmetric airfoil profile of NACA four digit series has a second opening, and the modified second symmetrical airfoil profile of NACA four digit series is defined by following equation:
$$y cos β - \frac{{w}_{1}}{{w}_{2}} x sin β = 5 {t}^{′} ( 0.2969 {m}^{0.5} - 0.126 m - 0.3516 {m}^{2} + 0.2843 {m}^{3} - 0.1015 {m}^{4} )$$
$$where$$
$$m = \frac{{w}_{1} cos β}{{w}_{2} c} x + \frac{sin β}{c} y + 1 , β = {tan}^{- 1} \frac{{y}_{3} - 0.0105 {t}^{′}}{c - {x}_{3}} ,$$
(x₃, y3) is coordinates of terminus of the second opening, wₗ is a width of the first opening, w₂ is a width of the second opening, and t′ is a thickness of the second symmetrical airfoil profile of NACA four digit series.

4. The vertical axis wind turbine blade according to claim 3, characterized in that the first opening has an arc length that is 10%˜90% of a length of an upper arc of the first symmetrical airfoil profile of NACA four digit series, and the second opening has an arc length that is 10%˜90% of a length of an upper arc of the second symmetrical airfoil profile of NACA four digit series.

5. The vertical axis wind turbine blade according to claim 1, characterized in that an inner cavity sandwich layer is formed between the outer profile and the inner profile, wherein the inner cavity sandwich layer has a reinforcement structure, and the reinforcement structure is a grid-like reinforcement structure or a reinforcement structure composed of ribbed plates and ribs.

6. A vertical axis rotor, characterized by comprising a rotor shaft and two or more vertical axis wind turbine blades according to claim 1, wherein the two or more vertical axis wind turbine blades are arranged evenly around an axis of the rotor shaft.

7. The vertical axis rotor according to claim 6, characterized in that the vertical axis rotor comprises an upper end cap and a lower end cap connected with the rotor shaft, and three vertical axis wind turbine blades are provided, wherein upper ends of the vertical axis wind turbine blades are connected with the upper end cap, and lower ends of the vertical axis wind turbine blades are connected with the lower end cap.

8. The vertical axis rotor according to claim 7, characterized in that an angle of 0˜120 degrees is included between a radial direction of the vertical axis rotor and a chord line of the outer profile of a cross section of each of the vertical axis wind turbine blades, with the cross section being perpendicular to the vertical axis.

9. The vertical axis rotor according to claim 7, characterized in that when wind blows toward the vertical axis rotor, a wind scoop of a wind turbine blade on a windward side directly converts coming airflow into kinetic energy, the rest airflow blows to the other two wind turbine blades, and airflow acceleratedly flowing over cambered surfaces of the other two wind turbine blades forms negative pressure so as to increase a rotating speed and a torque of the wind turbine blades.

10. A vertical axis wind power generation device, characterized by comprising a power generator and the vertical axis rotor according to claim 6, wherein a rotating shaft of the power generator is connected with the rotor shaft of the vertical axis rotor.
